(19) United States
(12) Patent Application Publication
(10) Pub. No.: US 2009/0080991 A1
(43) Pub. Date: Mar. 26, 2009

(54) Tool

(76) Inventors: Micheal Grimm, Pleissa (DE); Markus Heinloth, Postbauer-Heng (DE)

Correspondence Address: KENNAMETAL INC.;Intellectual Property Department, P.O. BOX 231, 1600 TECHNOLOGY WAY, LATROBE, PA, 15650, US

(21) Appl. No.: 11/658,073

(22) PCT Filed: May 12, 2005
(86) PCT No.: PCT/DE05/00871

§ 371 Date: Oct. 24, 2008

(30) Foreign Application Priority Data
Jul. 21, 2004 (DE) 10 2004 035289.5

(51) Int. Cl. B23D 41/04; B23D 37/00

(52) U.S. Cl. 409/287; 407/12; 409/243

(57) ABSTRACT

The invention relates to a disc-shaped or strip-shaped tool for machining, particularly, for cutting profiles on a workpiece such as a crankshaft that is rotated during machining, comprising a number of tangentially and radially mounted indexable inserts (21). According to the invention, at least a part of the tangentially mounted indexable inserts (21) has a recess (31) that, in the tangentially mounted indexable insert (21), extends into a portion of the supporting surface (27, 28) and into a portion of the radially situated face (23, 24), and into which an upper rear section of a radially mounted indexable insert projects whose upper front section (32) radially protrudes with regard to said face (23).

The invention relates to a disk-shaped or bar-shaped tool for machining, in particular for cutting profiles on a workpiece such as a crankshaft that is rotated during machining, having a plurality of tangentially and a plurality of radially mounted indexable inserts.

When manufacturing a crankshaft, the crankshaft is cast with certain dimensions in order to be able to perform subsequent machining operations with sufficient certainty. Tools for single- or double-rotation lathing are known from the prior art. In lathing, a linear lathing tool is pressed radially against the tool that is to be machined. In double-rotation lathing a plurality of successive cutting inserts are mounted on a reference circle circumference of a disk-shaped tool holder, and the cutting inserts project gradually and continuously more along a first segment of the disk circumference. This tool is pivoted in the radial direction against the rotating tool along a reference arc as is known in principle from EP 0 313 644 B1 or EP 0 286 771 A1. These tools use two geometrically different cutting inserts for shaft lathing and for finishing the undercut. Tools of the above-described type are shown and described for instance in DE 100 27 945 A1. In order to be able to provide a thinner cut during cutting and to be able to mount the greatest possible number of cutting tools on the side-lathing cutter, it is suggested that the tangentially mounted cutting inserts be mounted at an axial angle of inclination of 150 to 350 and that the rearmost cutting corner, seen opposite the lath rotation direction, is on a straight line perpendicular to the direction of rotation of the side-lathing cutter, which is spaced from the leading cutting edge of the subsequent radially mounted cutting insert by a distance of no more than 5 mm, preferably no more than 2 mm and extending into negative values.

When machining crankshafts, for instance for producing the crank pins using a double-rotation lathing method, and when the cutting operation begins immediately on the raw cast surface of crankshaft, the indexable inserts disposed on the tool are under extreme stress so that there is relatively high wear. In addition to the service life for the individually used indexable inserts, the costs are also largely a function of how many indexable inserts must be used per tool.

It is the object of the present invention to create a tool that permits cost-effective precutting of a crank pin for a crankshaft so that in the subsequent cutting process by means of a double-rotation lathing method only a minimum finish-machining amount must be removed, with which the double-rotation lathing tool used for the finish machining is less stressed, and whose service life is thus significantly improved. Furthermore, the new tool should have as many effective cutting edges as possible for a minimum number of indexable inserts used. Use of the indexable inserts should be flexible, i.e. it should be possible to use them for other cutting operations as well.

This object is attained using the tool in accordance with claim 1.

In accordance with the invention, at least a part of the tangentially mounted indexable inserts has a cutout that, in the tangentially mounted indexable insert, extends into a portion of the support face and into a portion of the radially situated face, and into which an upper rear portion of a radially mounted indexable insert projects whose upper front section radially projects with regard to the face. Using this measure it is possible to attain a particularly high number of effective cutting edges on the tool. While in the cutting insert arrangements in accordance with the prior art the radially mounted indexable inserts were mounted one after the other, alternately with the tangentially mounted indexable inserts, in accordance with the invention a radially mounted indexable insert and a tangentially mounted indexable insert can be mounted “in a line” so that when cutting crankshafts both cutting inserts can machine the crank pin base and the lateral surface of the crank pin simultaneously. This saves an additional operation and consequently also saves machining time.

Further embodiments of the invention are described in the subordinate claims.

Thus the width of the cutout is preferably no more than one-third of the width of the face and/or no more than one-half the height of the tangentially mounted indexable insert. Using these dimensions take into account that the cutout must not weaken the tangentially mounted indexable insert; on the other hand, a cutout that is too small in volume would create only a relatively small space for receiving the rear portion of the radially mounted indexable insert, and this could entail the risk that the radially mounted indexable insert is too weak in terms of dimensions in the area of the active cutting edges. Likewise, the width of the cutout is selected to be no more than one-half the thickness of the radially mounted indexable insert.

In order to render usable the greatest possible number of cutting edges, the tangentially mounted indexable insert has a respective cutout on each of its diametrically opposite sides.

Preferably the tangentially mounted indexable insert has two largely parallel broad faces through which a fastening bore passes and four adjacent lateral faces, specifically two at least largely parallel faces spaced apart from one another and two longitudinal faces disposed on opposite sides. The intersections of the broad faces with the longitudinal faces and the intersection of the broad faces with the transverse faces and also the transition area from the longitudinal face to the face, which is rounded (convex), form cutting edges. Preferably the tangentially mounted indexable insert also has eight usable cutting corners, each on the edge of the rounded transition area from the face to the broad face.

In accordance with another embodiment of the invention, each broad face has two subfaces that are slightly angled to one another, preferably at an enclosed angle >170°, preferably >175°, and furthermore the subface closer to toward the tool center is preferably smaller than the subface extending toward the edge.

The result is that a relatively thin cut can be made in the crank pin center because the cutting inserts are slightly angled there.

With respect to the radially mounted indexable inserts, preferably an embodiment in accordance with claim 9 or 10 is used. According to these, at least one part of the radially mounted indexable inserts has two largely parallel broad faces through which a fastening bore passes and that are joined on opposite sides at least by faces that in cross-section are at least partially convex, preferably semicylindrical and whose side edges are embodied as cutting edges. Preferably a base body that has a fastening bore and that expands to the center extends between the faces.

Preferably the tangentially-mounted and the radially mounted indexable inserts are mounted in a cassette, which facilitates their flexibility with respect to the design (setting of crank pin width, etc.) and also facilitates rapid exchangeability, specifically by switching cassettes.

In accordance with another embodiment of the invention, all indexable inserts are produced from a hard metal or a cermet body that has been produced using powder metallurgy by pressing and then sintering without intermediate processing. Where required the indexable inserts can also be coated, the composition of the coatings used being selected in a manner known per se in accordance with the prior art.

Additional advantages and embodiments are described in the following using the drawings. Therein:

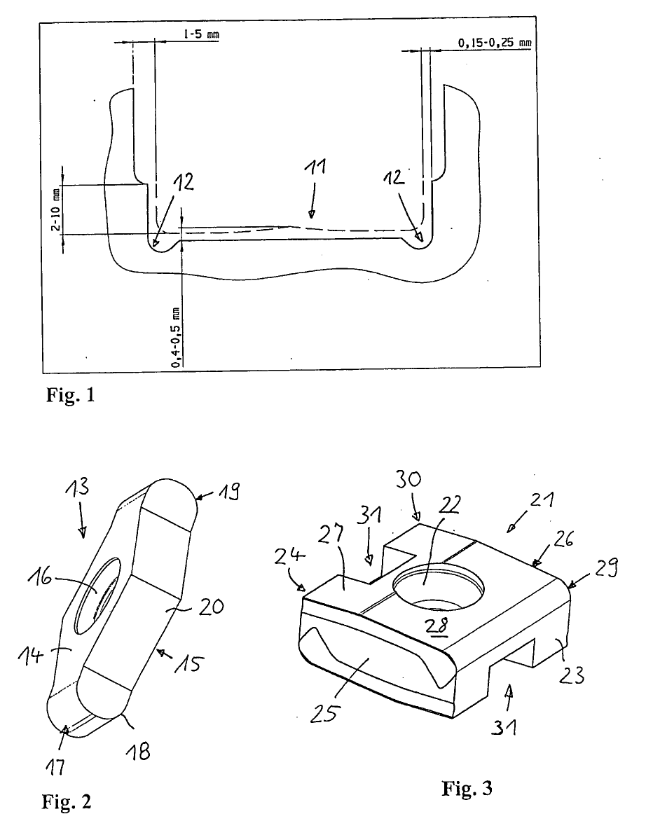

FIG. 1 is a sectional view of a lathed crank pin;

FIG. 2 is a perspective elevation of a-radially mountable cutting insert;

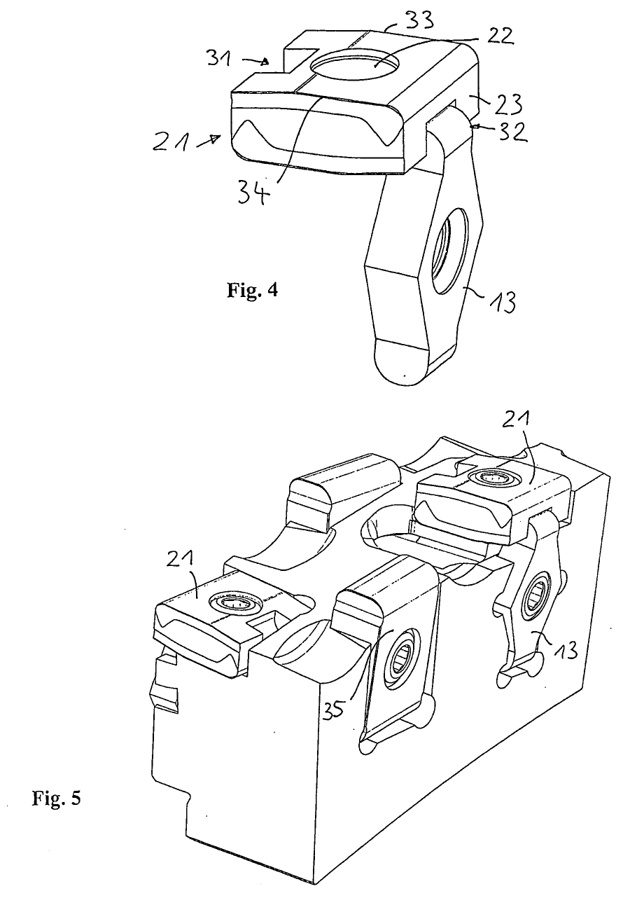

FIG. 3 is a perspective elevation of a tangentially mounted indexable insert;

FIG. 4 is a perspective elevation of the indexable inserts in accordance with FIGS. 2 and 3 for illustrating the “interfit” of the two indexable inserts;

FIG. 5 is the partial perspective view of an inventive tool.

FIG. 1 shows by way of example a section through a part of a crankshaft in which the side cheeks 10 are to be cut as well as the crank pin 11 and the undercuts 12. In this drawing the finish-machining amount that typically has to be removed using double-rotation-lathing are also provided as an example.

In order to obtain the cross-sectional shape shown in FIG. 1, two or three types of indexable inserts are used in the cassette of a tool holder in accordance with FIG. 5 for precutting, and these indexable inserts will be discussed in greater detail in the following. FIG. 2 shows an indexable insert 13 that can be mounted to extend radially and that has two parallel broad faces 14 and 15 through which passes a mounting bore 16 and that meet at opposite ends at semicylindrical faces 17 whose side edges 18 and 19 serve as cutting edges. The above-described at least largely semicylindrical faces 17 are situated at opposite ends of a base body 20 that is rhomboidal and that broadens toward the center in order to create a large enough space for the fastening bore 16. The four cutting edges 18 and 19 of this cutting body can be used successively by turning the indexable insert.

FIG. 3 shows a tangentially mountable indexable insert 21 that has two largely parallel broad faces through which a fastening hole 22 passes, and four adjacent lateral faces, specifically two at least largely parallel transverse faces 23 and 24 that are spaced apart from one another, and two longitudinal faces 25 and 26 disposed on opposite sides. The broad faces are slightly angled to one another and each are formed by two subfaces 27 and 28 forming between them an angle of about 175°. Like the edges where the faces 23 and 24 intersect the longitudinal faces 25 and 26, the edges where the subfaces 27 and 28 intersect the two longitudinal faces 25 and 26 form cutting edges, their transition areas being rounded so that cutting corners 29 are formed there having adjacent linear cutting edges approximately at a right angle of 90° to one another. In the embodiment shown in FIG. 3, there is a total of four rounded cutting corners 29 that are formed diametrically opposite one another. If the sharp corners 30 are also embodied as rounded cutting edges, eight usable cutting corners 29 result.

In accordance with the invention, the indexable insert 21 has, on diametrically opposite sides, cutouts 31 whose width is slightly larger than the width of the indexable insert 13 at each end face 17 so that the indexable insert 13 can assume the position shown in FIG. 4 in which the rear portion of one of the faces engages in the cutout 31, as shown. The front part 32 with exposed cutting corner sections there can be used for lathing side walls of a crank pin on crankshafts. The cutting edge 33 of the tangentially mounted cutting insert (or, when the direction of rotation is reversed, the opposite cutting edge 34) is used for machining the crank pin base 11. The tool used for this is seen in FIG. 5, in which another cutting insert 35 is also mounted radially and, if the indexable insert 21 is also provided with rounded cutting corners on the corners 30, can also comprise the indexable insert shown in FIG. 3. If the tool shown in FIG. 5 is used for precutting, only a minimum finish-machining amount of the crankshaft must be removed during final machining so that the significantly more expensive final double-rotation lathing tool is stressed much less and thus its service life is extended. The tool shown in FIG. 5 possesses a great number of effective cutting edges in the smallest possible space, the indexable inserts being used being those in accordance with FIGS. 2 and 3, i.e. in some circumstances, in other cutting operations. The crank pin width that can be produced can be varied by varying the overlap area of the indexable inserts 21 in the tool in accordance with FIG. 5 (on opposite sides).

The indexable inserts shown in FIGS. 2 and 3 can be mounted without washers or calibration pieces. All indexable inserts are advantageously produced using powder metallurgy from hard metals or cermet and do not undergo any mechanical post-processing after sintering apart of course from coating by means of PVD or CVD.

As was already mentioned to a certain degree, a particularly high number of effective cuts results from the principle of inserting the indexable insert 13 into the cutout of the indexable insert 21. Any bearing width required in practice, that is, from about 18 to 27 mm, can be produced by mounting the indexable insert 21 in a cassette. Since the precutting process can be done at relatively high speeds and only a small finish-machining amount must be machined in the subsequent double-rotation lathing process, and some cutting processes have been included during precutting, 4 to 6 seconds of machining time per unit can be saved in the entire cutting process. Since in addition the double-rotation lathing process employed for finish machining can be performed more rapidly, overall less cassettes per tool are used, which increases the service life for the final machining tool.

1. A disk-shaped or bar-shaped tool for machining, in particular for cutting profiles in a workpiece such as a crankshaft that is rotated during machining, having a plurality of tangentially and radially mounted indexable inserts, characterized in that
at least a part of the tangentially mounted indexable insert (21) has a cutout (31) that, in the tangentially mounted indexable insert (21), extends into a portion of a support face (27 and 28) and into a portion of the radially oriented face (23 and 24), and into which an upper rear portion of a radially mounted indexable insert (13) projects whose upper front section (32) radially projects with regard to the face (23).

2. The disk-shaped or bar-shaped tool in accordance with claim 1, characterized in that a width of the cutout (31) is no more than one-third of the width of the face (23 or 24) and/or no more than one-half the height of the tangentially mounted indexable insert (21) and/or is no more than one-half the thickness of the radially mounted indexable insert (13).

3. The tool in accordance with claim 1, characterized in that the tangentially mounted indexable insert (21) has a respective cutout (31) on diametrically opposite sides.

4. The tool in accordance with claim 1, characterized in that the tangentially mounted indexable insert (21) has two largely parallel broad faces through which a fastening bore (22) passes and four adjacent lateral faces, specifically two at least largely parallel transverse faces (23 and 24) spaced apart from one another and two longitudinal faces (25 and 26) on opposite sides.

5. The tool in accordance with claim 4, characterized in that the intersection between the broad faces and the longitudinal faces (25 and 26) and the faces (23 and 24) form cutting edges.

6. The tool in accordance with claim 5, characterized in that the cutting edges in the transition area from the longitudinal face to the face (23 and 24) are formed as rounded cutting corners.

7. The tool in accordance with claim 6, characterized in that the tangentially mounted indexable inserts (21) each have eight usable cutting corners (29).

8. The tool in accordance with claim 4, characterized in that the broad faces have two subfaces (27 and 28) that are slightly angled to one another, preferably the enclosed angle of inclination of the subfaces being >170°, in particular >175°, and furthermore the subface (27) extending toward the tool center is preferably smaller than the subface (28) extending toward the edge.

9. The tool in accordance with claim 1, characterized in that at least one part of the radially mounted indexable inserts (13) has two largely parallel broad faces (14 and 15) through which a fastening bore (16) passes and that are joined on opposite sides at least by faces (17) that in cross-section are at least partially convex, preferably semicylindrical and whose side edges (18 and 19) are embodied as cutting edges.

10. The tool in accordance with claim 9, characterized in that a base body (20) that has a fastening bore (16) and that expands to the center extends between the faces (17).

11. The tool in accordance with 1, characterized in that the tangentially mounted and the radially mounted indexable inserts (13 and 21) are mounted in a cassette.

12. The tool in accordance with 1, characterized in that all indexable inserts are made of a hard metal or a cermet body that has been produced using powder metallurgy by pressing and then sintering without intermediate mechanical processing.

13. A machining tool comprising:
a support having a longitudinally extending outer surface and a side surface;
a row of tangentially mounted indexable inserts secured to the outer surface and each formed with
oppositely directed broad faces,
a pair of longitudinal side faces bridging the broad faces,
a pair of transverse side faces-bridging the broad faces,
a cutout extending into the side face and the support face;
means for securing the tangential inserts to the support in a row with each of the tangential inserts bearing with one of the broad faces on the support outer surface, the other broad face turned away from the support, one of the longitudinal side faces extending generally parallel to and projecting transversely past the support side surface, and the cutout open toward the support outer face; and
respective radially mounted indexable inserts secured to the side face immediately adjacent each of the tangential inserts and each having an end portion seated in the respective cutout, the radial inserts projecting transversely from the cutouts of the respective tangential inserts.

14. The tool defined in claim 13 wherein each of the tangential inserts has at the respective cutout a longitudinal overall length and each of the cutouts has a longitudinal cutout length equal to at most one third the overall length.

15. The tool defined in claim 13 wherein each of the cutouts has an overall transverse depth parallel to the side face equal to at most half of an overall height of the side face.

16. The tool defined in claim 13 wherein each of the cutouts has an overall depth equal to at most half a thickness of the respective insert.

17. The tool defined in claim 13 wherein the indexable tangential insert is formed with two such side faces and two such cutouts, the indexable tangential inserts being plane symmetrical.

18. The tool defined in claim 13 wherein the means for securing is a respective hole through the tangential inserts generally centrally of the broad faces thereof.

19. The tool defined in claim 13 wherein each of the broad faces is formed of two substantially planar subfaces forming a wide acute angle of at least 170° open toward the other of the broad faces of the respective tangential insert.

20. The tool defined in claim 13 wherein the holder is a disk having a generally cylindrical outer periphery forming the longitudinal outer surface and centered on an axis and the side surface is an axially directed face of the disk.
